(19) United States
(12) Patent Application Publication
(10) Pub. No.: US 2006/0075486 A1
(43) Pub. Date: Apr. 6, 2006

(54) Self-contained token device for installing and running a variety of applications

(76) Inventors: Paul Lin, Fremont, CA (US); Fu-Hua Lee, Foster City, CA (US); Fred Cheng, Fremont, CA (US)

Correspondence Address: Jeffrey P. Aiello, 4911 Pony Pass Circle, San Jose, CA, 95136, US

(21) Appl. No.: 11/237,098

(22) Filed: Sep. 28, 2005

Related U.S. Application Data
(60) Provisional application No. 60/615,167, filed on Oct. 1, 2004.

(51) Int. Cl. H04L 9/32

(52) U.S. Cl. 726/20

(57) ABSTRACT

A token device that contains software and firmware required for running and installing a variety of applications is provided. The token is configured to connect to a host device via a USB port, wireless receiver or other means. The token may contain varying combinations of installers, applications, drivers, memory, and firmware. Token-related and non-token related applications that may be contained in the token's memory may include those required for smart card, cryptographic service provider, authentication, firewall, antivirus, and VPN type applications.

### CROSS-REFERENCE TO RELATED APPLICATIONS

This Application is a non-provisional application of Provisional Application No. 60/615,167, filed on Oct. 1, 2004.

### BACKGROUND OF THE INVENTION

1. Field of the Invention

The present invention relates to computer token devices, and more particularly, to a token device that contains software and firmware necessary to self-install and run a variety of applications.

2. Background Information

Private and public computer networks, including the Internet, are commonly used by individuals and business. The Internet, for example, may be used to access “on-line” businesses by individuals to purchase goods or services, to access personal information, update data, and so forth. Due to the confidential nature of information and data that may be accessed and transmitted over the network, it may be desired to keep some data and information on the computer network confidential or private. Thus, access to this data and information may be controlled.

An on-line business, such as a banking institution's website, may require that a user authenticate himself before allowing access to the confidential information. Authentication is the process of determining whether someone or something is, in fact, who or what they claim to be. To authenticate, the user may input a username and password. If the username and password input by the user matches the usemame and password associated with the data the user it attempting to access, the user is authenticated and can access the data.

A known weakness in this system is that usernames and passwords can often be cracked, stolen, accidentally revealed, or forgotten. For these reasons, Internet businesses and other computer networks may require a more stringent authentication process.

Two-factor authentication, sometimes referred to as strong authentication, is an authentication protocol that requires two forms of authentication to access a system. The first form, or factor, in the authentication may be something the user knows such as a password or Personal Identification Number (PIN). The second factor may be something the user has, such as a computer token device or a smart card, for example. Since a computer token device is typically assigned to a particular individual, the token device is useful for authenticating user identification.

Computer token devices, also known as personal tokens, or tokens, are available in various form factors. A common form factor of a personal token comprises a USB token. USB tokens contain a processor for processing information and a solid-state memory for securely storing data. USB smart tokens typically measure approximately 2.5 inches long and 0.5 inches wide, about the size of a house key, and are designed to interface with the Universal Serial Bus (USB) ports found on computers and peripheral devices.

An advantage of known USB tokens is that special hardware readers are not required for operation of the token. Another known advantage of known tokens, is that little or no modification to existing systems and applications is required for operation of the token.

However, a disadvantage of known tokens is that token device drivers must be installed and configured on a host device, prior to using the token.

Thus, a token device that contains software and firmware necessary to self-install and run a variety of applications would be advantageous over the prior art.

### BRIEF SUMMARY OF THE INVENTION

The present invention comprises of a token device which contains software and firmware required for running and installing a variety of applications. The token is configured to connect to a host device via a USB port, wireless receiver or other means. The token may contain varying combinations of installers, applications, drivers, memory, and firmware. Token-related and non-token related applications that may be contained in the token's memory may include those required for smart card, cryptographic service provider, authentication, firewall, antivirus, and Virtual Private Network (VPN) type applications.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic diagram of an embodiment of a token device of the present invention coupled to a computer; and

FIG. 2 and FIG. 3 are flow diagrams showing a preferred embodiment of the functionality of the present invention.

### DESCRIPTION OF THE PREFERRED EMBODIMENTS

The present invention comprises of a token device which contains software and firmware required for running and installing a variety of applications. The token is configured to connect to a host device via a USB port, wireless receiver or other means. The token may contain varying combinations of installers, applications, drivers, memory, and firmware. Token-related and non-token related applications that may be contained in the token's memory may include those required for smart card, cryptographic service provider, authentication, firewall, antivirus, and Virtual Private Network (VPN) type applications.

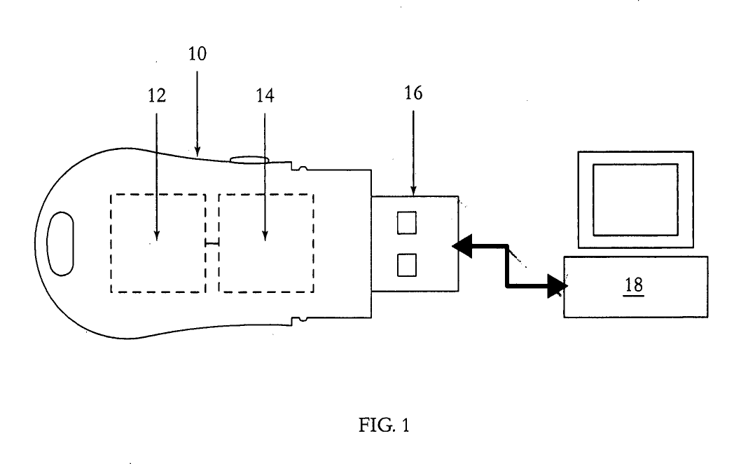

Referring to FIG. 1, there is shown, generally at 10, an embodiment of the invented portable, self-contained, and multifunctional computer token device 10. The computer token device 10 is often referred to in the art at a personal token or token. Hereinafter, the invented computer token device 10 will be referred to as a token.

The token 10 may include an on-board processor 12 for processing data and memory device 14 for storing data. Preferably, the memory device 14 comprises a non-volatile, solid state memory device, such as a Flash memory device. Firmware may be stored in the processor 12, while various installers, applications and drivers may be stored in memory 14.

The token 10 may be provided with a connector 16 for coupling the token 10 to a host device, such as a host computer 18. The connector 16 may comprise a known connector, such as a Universal Serial Bus (USB) connector for coupling the token 10 to a USB port of the host computer 18, for example.

The host computer 18 is provided with a known operating system that typically includes a multiplicity of drivers. Coupling the token 10 to the computer 18 activates the token 10 and commences operation of the token 10. Once the token 10 is connected to the host computer 18, a driver in the operating system of the host computer 18 is activated to provide communication between the host computer 18 and token 10.

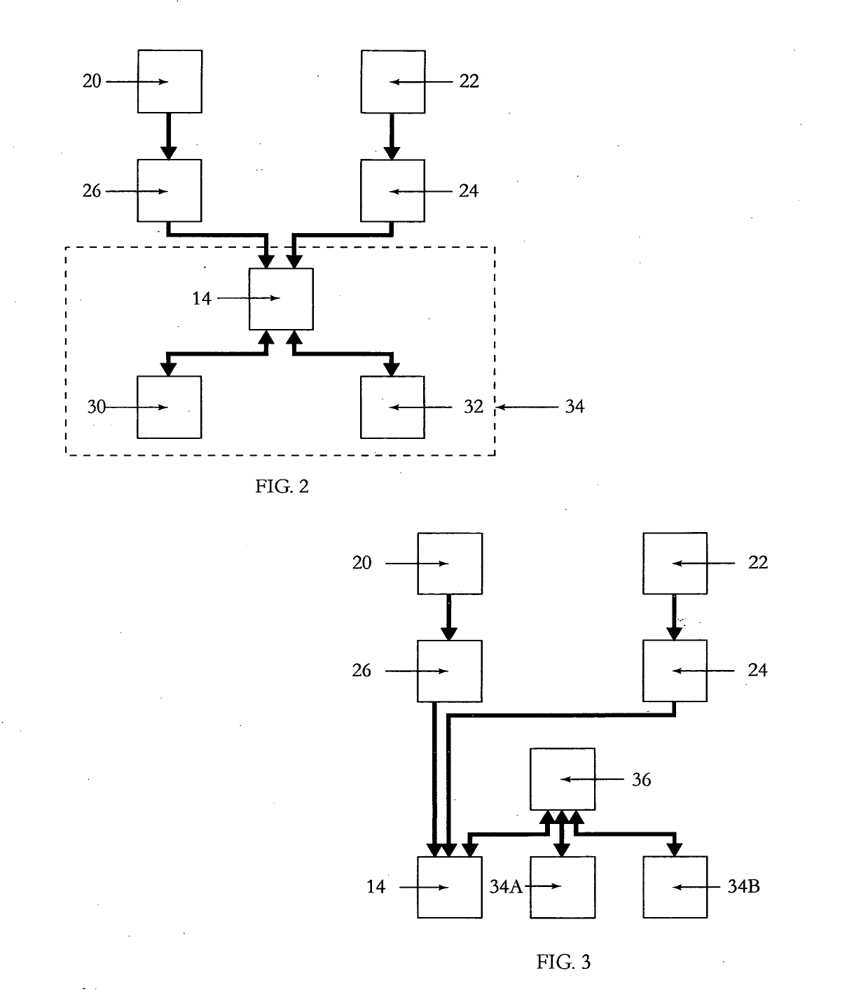

Referring to FIG. 2 and FIG. 3 of the drawings, once communication between the host computer 18 and token 10 is established, the token 10 then retrieves a desired application, shown in box 20, and its own on-board installer, shown in box 22 from its memory device 14. As is well known, the installer then runs on the host computer 18 to load the application onto the computer 18. One or more drivers, shown in box 24 and box 26, may also be retrieved from the token's memory 14 to configure the application for the operating system of the computer 18, to ensure that the application will run on the host computer 18.

Once the application is installed and configured, the application may run on the host computer 18. Thus, everything needed to install and run the applications and drivers are contained within the token 10 including any hardware and firmware required to run token-related applications. These token-related applications may include smart card, cryptographic service provider, authentication, firewall, antivirus, and VPN type applications.

Referring still to FIG. 2 and FIG. 3, in an alternative embodiment, the invented token 10 may be designed where separate firmware 30, 32, or memory 14, or both, that may be required for the running the applications stored in the token 10, are also contained on the token 10. The firmware 30, 32, or memory 14, or both, may be contained on the token 10, by installing the firmware 30, 32 and/or memory 14 onto a single device 34 within the token 10.

Alternatively, the firmware 30, 32 and/or memory 14 may be contained on the token 10, by installing the firmware 30, 32 and/or memory 14 onto separate devices 34A and 34B contained within the token 10. As shown in FIG. 3, the devices 14, 34A and 34B may be connected via known circuitry 36. For example, a USB hub chip, or circuitry configured on a chip board, as is known in the art, may be used for connecting the devices 14, 34A and 34B.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A token device comprising:
a processor for processing data;
a memory device for storing data; and
at least one of an installer program and an application stored in the memory device.

2. The token device of claim 1 further comprising:
at least one of an installer program, an application, and a driver stored in the memory device.

3. The token device of claim 2 wherein an application stored in the memory device comprises an application selected from the group consisting of a smart card application, a cryptographic service provider application, an authentication application, a firewall application, an antivirus application, and a virtual private network application.

4. The token device of claim 1 further comprising:
firmware stored in the token device.

5. A token device comprising:
a processor for processing data, the processor configured with firmware for running an application;
a memory device for storing data, the memory device coupled to the processor; and
at least one of an installer program, an application, and a driver stored in the memory device.

6. The token device of claim 5 wherein an application stored in the memory device comprises an application selected from the group consisting of a smart card application, a cryptographic service provider application, an authentication application, a firewall application, an antivirus application, and a virtual private network application.

7. A method for installing and running an application stored on a token device, the method comprising the following steps:
(a) coupling a token device to a host device to activate the token device;
(b) retrieving a selected application from a memory of the token device;
(c) invoking an installer from the memory of the token device to configure the selected application to run on the host device; and
(d) running the selected application on the host device.

8. The method claim 7 further comprising:
(e) invoking a driver to enable the host device to communicate with the token device.

9. The method of claim 7 wherein the selected application comprises an application selected from the group consisting of a smart card application, a cryptographic service provider application, an authentication application, a firewall application, an antivirus application, and a virtual private network application.
